(19) United States
(12) Patent Application Publication
(10) Pub. No.: US 2010/0075207 A1
(43) Pub. Date: Mar. 25, 2010

(54) BATTERY LIFE ALARM SYSTEM AND BATTERY LIFE ALARM METHOD

(75) Inventor: Wei-Ting YEN, Taipei City (TW)

Correspondence Address: RABIN & Berdo, PC, 1101 14TH STREET, NW, SUITE 500, WASHINGTON, DC, 20005, US

(73) Assignee: Quanta Computer Inc., Tao Yuan Shien (TW)

(21) Appl. No.: 12/412,436

(22) Filed: Mar. 27, 2009

(30) Foreign Application Priority Data
Sep. 22, 2008 (TW) 97136371

(51) Int. Cl. H01M 10/48

(52) U.S. Cl. 429/90

(57) ABSTRACT

A battery life alarm system and a battery life alarm method are provided. The battery life alarm system includes a first arithmetic unit, a second arithmetic unit and a third arithmetic unit. The first arithmetic unit outputs a capacity ratio according to a sense voltage and a design capacity of a battery. The second arithmetic unit outputs a life ratio according to a used life parameter and a design life parameter of the battery, wherein the used life parameter and design life parameter correspond to the using time or the charge/discharge times of the battery. The third arithmetic unit outputs a life index according to the capacity ratio, the life ratio and a weighted percentage.

This application claims the benefit of Taiwan application Serial No. 971 36371, filed Sep. 22, 2008, the subject matter of which is incorporated herein by reference.

### BACKGROUND OF THE INVENTION

1. Field of the Invention

The invention relates in general to a battery life alarm system and a battery life alarm method, and more particularly to a battery life alarm system and a battery life alarm method enabling a user to obtain the battery life directly.

2. Description of the Related Art

Normally, a user would charge the battery of a notebook computer with an adaptor. When power socket is unavailable or the user is outside, battery is the main power supply to the notebook computer. Thus, the normal operation of the notebook computer largely depends on battery quality.

However, during the selection of a battery, it is very difficult for a user to judge battery life by the appearance of a battery. Thus, if a user happens to buy a poor-quality battery, the security of the notebook computer and the user would be severely affected.

### SUMMARY OF THE INVENTION

The invention is directed to a battery life alarm system and a battery life alarm method enabling the user to understand battery life directly, hence avoiding purchasing a poor-quality battery.

According to a first aspect of the present invention, a battery life alarm system is provided. The battery life alarm system includes a first arithmetic unit, a second arithmetic unit and a third arithmetic unit. The first arithmetic unit outputs a capacity ratio according to a sense voltage and a design capacity of a battery. The second arithmetic unit outputs a life ratio according to a used life parameter and a design life parameter of the battery, wherein the used life parameter and design life parameter correspond to the using time or the charge/discharge times of the battery. The third arithmetic unit outputs a life index according to the capacity ratio, the life ratio and a weighted percentage.

According to a second aspect of the present invention, a battery life alarm method is provided. The battery life alarm method includes the following steps. Firstly, a capacity ratio is outputted according to a design capacity and a sense voltage of a battery. Next, a life ratio is outputted according to a used life parameter and a design life parameter of the battery, wherein the used life parameter and the design life parameter correspond to the using time or the charge/discharge times of the battery. Lastly, a life index is outputted according to the capacity ratio, the life ratio and a weighted percentage.

The invention will become apparent from the following detailed description of the preferred but non-limiting embodiments. The following description is made with reference to the accompanying drawings.

### BRIEF DESCRIPTION OF THE DRAWINGS

FIG. 1 shows a block diagram of a battery life alarm system according to a preferred embodiment of the invention;

FIG. 2 shows a detailed block diagram of FIG. 1;

FIG. 3 shows a circuit diagram of FIG. 2;

FIG. 4 shows an indication unit; and

FIG. 5 shows a block diagram of a battery life alarm method according to a preferred embodiment of the invention.

### DETAILED DESCRIPTION OF THE INVENTION

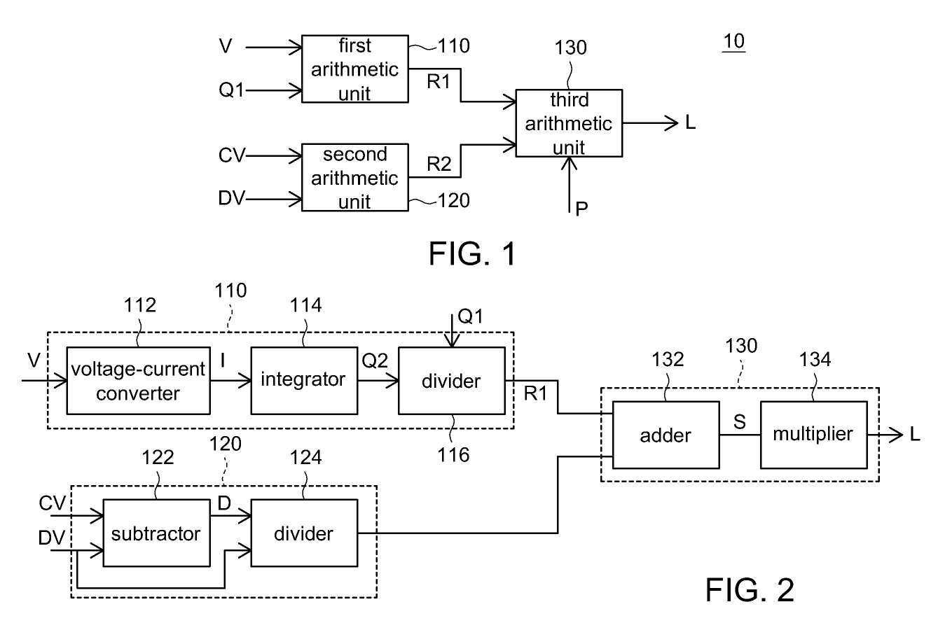

Referring to FIG. 1, a block diagram of a battery life alarm system according to a preferred embodiment of the invention is shown. The battery life alarm system 10 includes a first arithmetic unit 110, a second arithmetic unit 120 and a third arithmetic unit 130. The first arithmetic unit 110 outputs a capacity ratio R1 according to a design capacity Q1 of a battery and a sense voltage V. The sense voltage V is obtained from a sense resister on a battery charge/discharge loop. The second arithmetic unit 120 outputs a life ratio R2 according to a used life parameter CV and design life parameter DV of the battery, wherein the used life parameter CV and design life parameter DV correspond to the using time or the charge/discharge times of the battery. The third arithmetic unit 130 outputs a life index L according to the capacity ratio R1, life ratio R2 and a weighted percentage P.

The above battery is a battery of a notebook computer, and the design life parameter DV is a cycle life or a time life for example. The cycle life is a maximum charge/discharge times of the battery. If a battery is used as a second-time battery, the more charge/discharge times the better. Thus, the cycle life is an important index for measuring the economic value of the second-time battery. The design capacity of a battery is fixed, but the capacity of the battery will decrease due to aging.

Let the cycle life be 300 charge/discharge times for example. After 300 charge/discharge times, the capacity of the battery must be at least 80% of the original design capacity. That is, a 1000 mAh battery must have the capacity of 800mAh after 300 charge/discharge times. Also, there are manufacturers setting the cycle life of the battery to 500 charge/discharge times. After 500 charge/discharge times, the capacity of the battery must be at least 60% of the original design capacity. That is, a 1000 mAh battery must have the capacity of 600 mAh after 500 charge/discharge times.

The above time life is mean time between failure (MTBF), which is the expected value of reliability. That is, the average time for the reliability of a battery to be reduced to a predetermined percentage after a period of continual work.

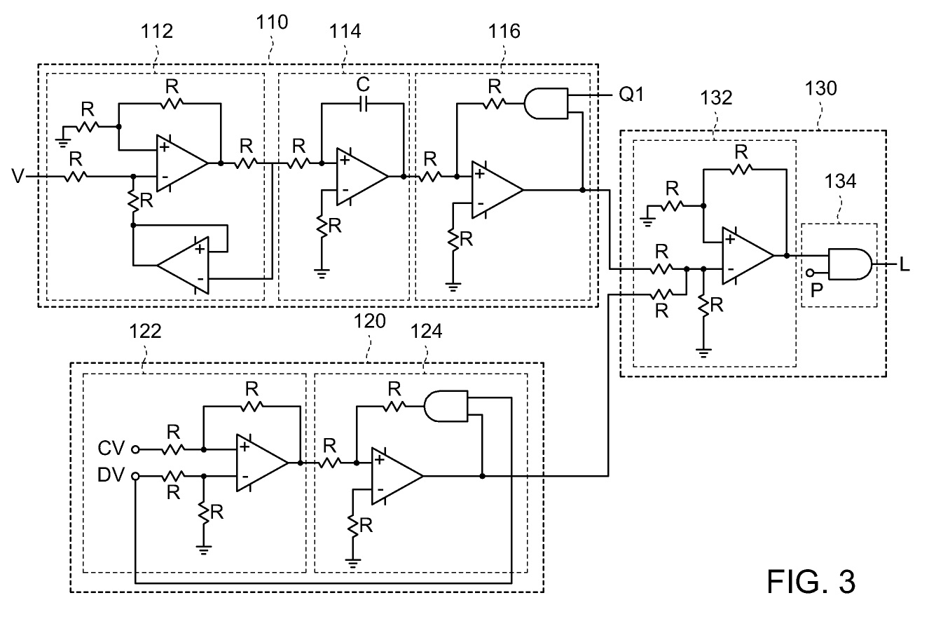

Referring to FIG. 2 and FIG. 3. FIG. 2 shows a detailed block diagram of FIG. 1. FIG. 3 shows a circuit diagram of FIG. 2. Furthermore, the first arithmetic unit 110 includes a voltage-current converter 112, an integrator 114 and a divider 116. The voltage-current converter 112 converts the sense voltage V on a sense resister of a charge/discharge loop to a sense current I. The integrator 114 integrates the sense current I to output a current capacity Q2 of the battery. The divider 116 divides the current capacity Q2 by the design capacity Q1 to output a capacity ratio R1.

The arithmetic unit 120 includes a subtractor 122 and a divider 124. The subtractor 122 subtracts the design life parameter DV from the used life parameter CV to output a difference D. The divider 124 divides the difference D by the design life parameter DV to output a life ratio R2.

The arithmetic unit 130 includes an adder 132 and a multiplier 134. The adder 132 adds the capacity ratio R1 and the life ratio R2 to output a sum S. The multiplier 134 multiplies the sum S with a weighted percentage P to output a life index L. The weighted percentage P is 50% for example. That is, the capacity ratio R1 and the life ratio R2 are both 50%. In short, in order to correctly evaluate the battery life, the life index of a battery is redefined as:

$$[ \frac{Q 2}{Q 1} + \frac{( DV - CV )}{DV} ] \times 50 \% .$$

There are two types of batteries currently available in the market, namely, smart battery and dump battery. Smart battery having a battery management unit (BMU) can correctly detects the charge cutoff when the state of the battery is monitored, hence avoiding overcharge. However, the charge cutoff of a dump battery is subjected to environmental factors, therefore the accuracy is poor, and the dump battery may even be over-charged.

The design life parameter DV and the used life parameter CV depend on whether the smart battery or the dump battery is used. When the parameter is used in a smart battery, the design life parameter DV is the design cycle life, and the used life parameter CV is the used cycle life. The life index of battery is defined as:

$$[ \frac{\begin{matrix}current \\ capacity\end{matrix}}{\begin{matrix}design \\ capacity\end{matrix}} + \frac{( design . cycle . life - used . cycle . life )}{\begin{matrix}design \\ cyclelife\end{matrix}} ] \times 50 \% .$$

Likewise, when the parameter is used in a dump battery, the design life parameter DV is the design time life, the used life parameter CV is the used time life, and the life index of the battery is defined as:

$$[ \frac{\begin{matrix}current \\ capacity\end{matrix}}{\begin{matrix}design \\ capacity\end{matrix}} + \frac{( design . time . life - used . time . life )}{\begin{matrix}design \\ timelife\end{matrix}} ] \times 50 \% .$$

Thus, the complete history of the battery from manufacturing to the current is available, and the life index L outputted by the third arithmetic unit 130 is outputted to a battery management unit or an indication unit according to which type of battery is used.

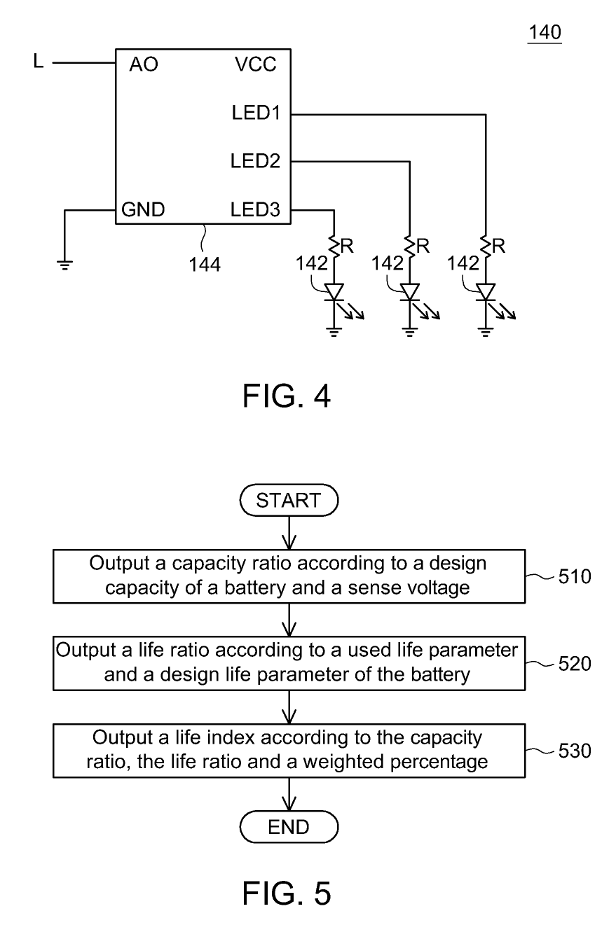

Referring to FIG. 4, an indication unit is shown. The indication unit can be designed in various forms to fit actual needs, and the indication unit of the invention is not limited to the indication unit illustrated in FIG. 4. To make the invention easier to understand, an indication unit is illustrated in FIG. 4. The indication unit 140 includes several light emitting elements 142, several resistors R and a multiplexer 144. The light emitting elements 142 are exemplified by light emitting diodes for example, and the resistors R are used for limiting the current flowing through the light emitting elements 142. The multiplexer 144 drives the light emitting elements 142 according to a life index L.

The user judges the battery life according to the number or the color of the light emitting elements 142 are turned on. For example, three light emitting elements being turned on indicate that the battery is brand new; two light emitting elements being turned on indicate that only half of the battery life is left; one light emitting element being turned on indicates that the battery life will finish soon. Or, a green light emitting elements being turned on indicates that the battery is brand new, a yellow light emitting element being turned on indicate that only half of the battery life is left; a red light emitting element being turned on indicates that the battery life will finish soon.

As the battery life alarm system 10 of FIG. 1 can be disposed in a battery module directly, the user not only immediately understands the current state of the battery but also avoids purchasing a poor-quality battery, hence largely increasing the convenience of use.

Referring to FIG. 5, a block diagram of a battery life alarm method according to a preferred embodiment of the invention is shown. The battery life alarm method is applicable to the battery life alarm system 10 and includes the following steps. Firstly, the method begins at step 510, a capacity ratio R1 is outputted by a first arithmetic unit 110 according to a design capacity Q1 and a sense voltage V of a battery. Next, the method proceeds to step 520, a life ratio R2 is outputted by a second arithmetic unit 120 according to a used life parameter CV and a design life parameter DV of a battery. Lastly, the method proceeds to step 530, a life index L is outputted by a third arithmetic unit 130 according to the capacity ratio R1, the life ratio R2 and a weighted percentage P.

According to the battery life alarm system and the battery life alarm method disclosed in the above embodiments of the invention, the user not only immediately understands the current state of the battery but also avoids purchasing a poor-quality battery, hence largely increasing the convenience of use.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A battery life alarm system, comprising:
a first arithmetic unit used for outputting a capacity ratio according to a design capacity of a battery and a sense voltage;
a second arithmetic unit used for outputting a life ratio according to a used life parameter and a design life parameter of the battery, wherein the used life parameter and the design life parameter correspond to the using time or the charge/discharge times of the battery; and
a third arithmetic unit used for outputting a life index according to the capacity ratio, the life ratio and a weighted percentage.

2. The battery life alarm system according to claim 1, wherein the design life parameter is a cycle life.

3. The battery life alarm system according to claim 1, wherein the design life parameter is a time life.

4. The battery life alarm system according to claim 3, wherein the time life is mean time between failure (MTBF).

5. The battery life alarm system according to claim 1, wherein the first arithmetic unit comprises:
a voltage-current converter used for converting the sense voltage to a sense current;
an integrator used for integrating the sense current to output a current capacity; and
a divider used for dividing the current capacity by the design capacity to output the capacity ratio.

6. The battery life alarm system according to claim 1, wherein the second arithmetic unit comprises:
a subtractor used for subtracting the design life parameter from the used life parameter to output a difference; and
a divider used for dividing the difference by the design life parameter to output the life ratio.

7. The battery life alarm system according to claim 1, wherein the third arithmetic unit comprises:
an adder used for adding the capacity ratio and the life ratio to output a sum; and
a multiplier used for multiplying the sum with the weighted percentage to output the life index.

8. The battery life alarm system according to claim 7, wherein the multiplier is a AND gate.

9. The battery life alarm system according to claim 1, wherein the life index is outputted to a battery management unit (BMU).

10. The battery life alarm system according to claim 1, wherein the life index is outputted to an indication unit used for indicating the life index.

11. The life alarm system according to claim 10, wherein the indication unit comprises:
a plurality of light emitting elements;
a plurality of resistors used for limiting the current flowing through the light emitting elements; and
a multiplexer used for driving the light emitting elements according to the life index.

12. A battery life alarm method, comprising:
(a) outputting a capacity ratio according to a design capacity of a battery and a sense voltage;
(b) outputting a life ratio according to a used life parameter and a design life parameter of the battery, wherein the used life parameter and the design life parameter correspond to the using time or the charge/discharge times of the battery; and
(c) outputting a life index according to the capacity ratio, the life ratio and a weighted percentage.

13. The battery life alarm method according to claim 12, wherein the design life parameter is a cycle life.

14. The battery life alarm method according to claim 12, wherein the design life parameter is a time life.

15. The battery life alarm method according to claim 14, wherein the time life is mean time between failure (MTBF).

16. The battery life alarm method according to claim 12, wherein the step (a) comprises:
(a1) converting the sense voltage to a sense current;
(a2) integrating the sense current to output a current capacity; and
(a3) dividing the current capacity by the design capacity to output the capacity ratio.

17. The battery life alarm method according to claim 12, wherein the step (b) comprises:
(b1) subtracting the design life parameter from the used life parameter to output a difference; and
(b2) dividing the difference by the design life parameter to output the life ratio.

18. The battery life alarm method according to claim 12, wherein the step (c) comprises:
(c1) adding the capacity ratio and the life ratio to output a sum; and
(c2) multiplying the sum with the weighted percentage to output the life index.

19. The battery life alarm method according to claim 12, further comprising:
(d) outputting the life index to a battery management unit (BMU).

20. The battery life alarm method according to claim 12, further comprising:
(d) outputting the life index to an indication unit used for indicating the life index.
